(19) United States
(12) Patent Application Publication
(10) Pub. No.: US 2021/0403240 A1
(43) Pub. Date: Dec. 30, 2021

(54) METHOD FOR OPERATING A PALLET PICK PUT SYSTEM FOR TRANSPORTING OBJECTS

(71) Applicant: Grey Orange Pte, Ltd., Singapore (SG)

(72) Inventors: Mohit Kumar, Merrut (IN); Nitin Pancholi, Jaipur (IN); Anuj R Jha, Ahmedabad (IN)

(21) Appl. No.: 17/289,864

(22) PCT Filed: Oct. 30, 2019
(86) PCT No.: PCT/IB2019/059293

§ 371 Date: Apr. 29, 2021

(30) Foreign Application Priority Data
Oct. 30, 2018 (GB) 1817706.3

(51) Int. Cl. B65G 1/137; B65G 1/06

(52) U.S. Cl. CPC B65G 1/1378; B65G 2201/0267; B65G 2207/40; B65G 1/065

(57) ABSTRACT

A method for transporting objects using a pallet pick put system. The method includes placing an Object Carrying Unit (OCU) at a first location by a bot. The bot is designed to move the Object Carrying Unit (OCU) and receives an address of the first location. Further, the Object Carrying Unit (OCU) is clamped by a clamping unit to restrict movement of the Object Carrying Unit (OCU). A pallet and an object placed over the pallet are lifted using a mechanical equipment designed for transporting objects. Further, the pallet and the mechanical equipment are aligned by an alignment unit. Further, the pallet and the object are transferred on the Object Carrying Unit (OCU). Thereafter, the bot is instructed to carry the Object Carrying Unit (OCU) upon loading to a second location after the Object Carrying Unit (OCU) is released by the clamping unit.

### TECHNICAL FIELD

The present disclosure is generally related to a pallet pick put system, and is more particularly related to a method (of) for transporting objects using the pallet pick put system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Manufacturers and distribution centers receive orders from stores for a variety of merchandise. Typically, a given order is “picked” which means that a manufacturer or distribution center uses a pallet that is carried on forks of a pallet conveyance, onto which objects are loaded for delivery to a given location. Such pallet conveyances may include a forklift truck, a motorized pallet jack, or a manual pallet jack. Such pallet conveyances are entirely manual in operation, and thus such a system provides very low throughput.

Further, individual object storage and delivery systems are used to store pallets of different products and variations in products, such as size, color, quantity, and flavoring. Such individual object storage and delivery systems mechanize a process of filling orders for multiple objects having different pallets, in an efficient and reliable manner. However, such individual object storage and delivery systems are expensive, difficult to install, and require a great deal of floor space. Further, an automation solution is used to reduce an amount of manual labor required to fill the customer orders. In an example, Intelligent Control Systems are used to track customer orders, inventory, and routing of the inventory for filling the orders.

Further, transportation of articles requires a lot of skill for executing handling and stability of the articles. Currently, the transportation of the articles is either performed manually or is completely automated. However, the manual transportation of the articles is time consuming, requires skilled and experienced employees, and generally leads to human errors. On the other hand, transportation of the articles in a fully automated environment leads to high operation costs. Therefore, there is a need for an improved method for transporting the articles that may be efficient, cost effective, easy to install, time efficient, and secure.

### SUMMARY OF THE DISCLOSURE

In one aspect of the present disclosure, a method for transporting objects using a pallet pick put system is provided. The method is characterized by placing an Object Carrying Unit (OCU) at a first location, by a bot. The bot is designed to move the OCU and receives an address of the first location from a server. Further, the method includes clamping the OCU by a clamping unit to restrict movement of the OCU. A pallet and an object placed over the pallet are lifted using a mechanical equipment designed for transport of objects. The method further includes aligning at least one of the pallet and the mechanical equipment by an alignment unit. The alignment unit comprises a pallet aligner and a mechanical equipment aligner. The method is further characterized by loading the pallet and the object placed over the pallet, on the OCU. Thereafter, the method is characterized by instructing, by the server, the bot to carry a loaded OCU to a second location. The clamping unit releases the OCU for allowing the bot to carry the OCU upon loading, thereby transporting the objects.

In one aspect of the present disclosure, a pallet pick put system for transporting objects is provided. The pallet pick put system is characterized by an Object Carrying Unit (OCU) placed at a first location by a bot. The bot is designed to move the OCU and receives an address of the first location from a server. The pallet pick put system is characterized by a clamping unit for clamping the OCU to restrict movement of the OCU. Further, the pallet pick put system is characterized by a pallet and an object placed over the pallet. The pallet is lifted using prongs of a mechanical equipment designed for transport of objects. Further, the pallet pick put system is characterized by an alignment unit for aligning at least one of the pallet and the mechanical equipment. The alignment unit comprises a pallet aligner and a mechanical equipment aligner. Further, the pallet and the object placed over the pallet are loaded on the OCU. The bot is instructed by the server to carry a loaded OCU to a second location. Therefore, the clamping unit releases the OCU for allowing the bot to carry the OCU upon loading, thereby transporting the objects.

The current disclosure aims at improving accuracy, throughput, and operational speed of a pallet pick put system. An incorrect handling of the mechanical equipment by an operator generally results in damage of the mechanical equipment and other elements such as OCU, upon collision with the mechanical equipment. To rectify such problem, the current disclosure provides a clamping unit to restrict movement of an OCU while loading an object onto the OCU. In such a case, even when the mechanical equipment accidentally hits a clamped OCU, the OCU will not leave its position. Further, the clamping unit also corrects mispositioning of the OCU created while being carried by the bot.

In another case, the operator may incorrectly handle the mechanical equipment and may bring the mechanical equipment towards the OCU, at an appropriately angle. Such misalignment could result in falling of the pallet and the object placed over the pallet. This could lead to increased operational costs and additional operation time to rectify the damage. To rectify such problem, current disclosure provides an alignment unit for aligning the mechanical equipment and the pallet.

An obstruction present in a path of the mechanical equipment generally results in damage to the mechanical equipment. To rectify such problem, current disclosure provides one or more safety sensors that are used for determining presence of an obstruction in a path of the mechanical equipment. Upon detection of an obstruction, movement of the mechanical equipment could be immediately brought to a halt, avoiding any accidental damage.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A is an illustration of a transfer of objects from a manually operated environment 10 to a warehouse 20, management of the objects in the warehouse 20, and management of the objects in a Goods-To-Person (GTP) environment 30.

FIG. 1B is an illustration of a perspective view of a pallet pick put system 102 operating in the warehouse 20, for transporting objects, according to an embodiment.

FIGS. 2A and 2B are cumulatively illustrations of a flowchart 200 showing a method for transporting objects using the pallet pick put system 102, according to an embodiment.

FIG. 3 is an illustration of a perspective view of the pallet pick put system 102 showing positioning of a clamping unit 128 and a pair of photoeyes 302, according to an embodiment.

FIG. 4 is an illustration of a perspective view of the pallet pick put system 102 showing an alignment unit 122, according to an embodiment.

FIG. 5 is an illustration of a flowchart 500 showing a method for transporting objects using a pallet pick put system 102, according to an embodiment.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

In overview, embodiments of the present disclosure are concerned with a pallet pick put system for managing movement of objects in a warehouse. Moreover, embodiments of the present disclosure are concerned with a clamping unit for clamping Object Carrying Units (OCUs). Furthermore, embodiments of the present disclosure are concerned with an alignment unit for aligning elements of the pallet pick put system, such as a pallet and a mechanical equipment. Furthermore, embodiments of the present disclosure are concerned with a safety module for avoiding accidents during operation of the pallet pick put system.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

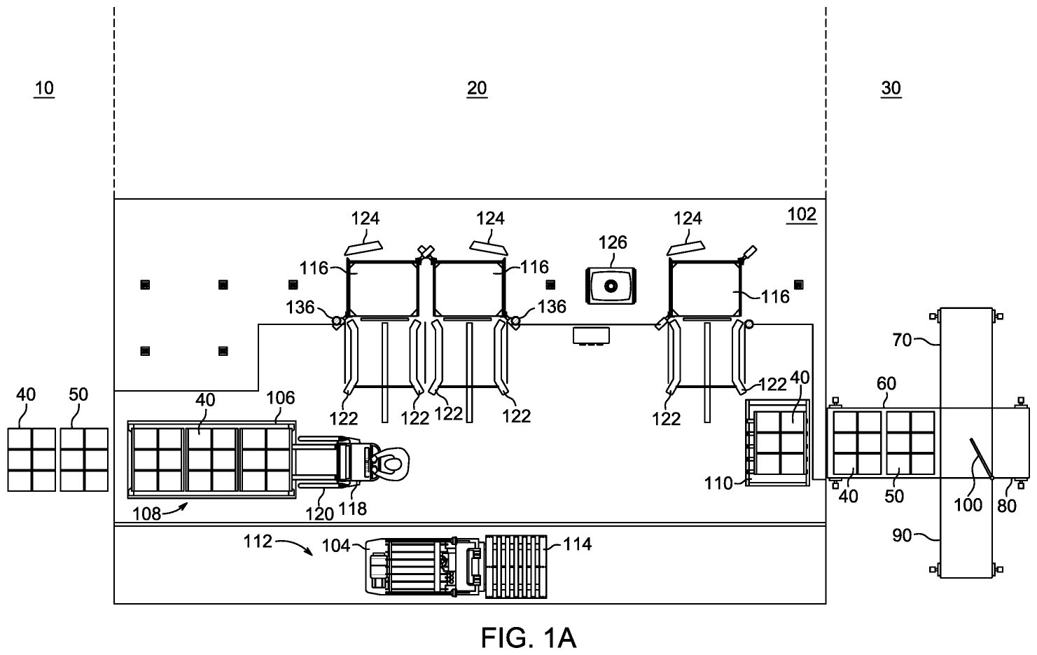

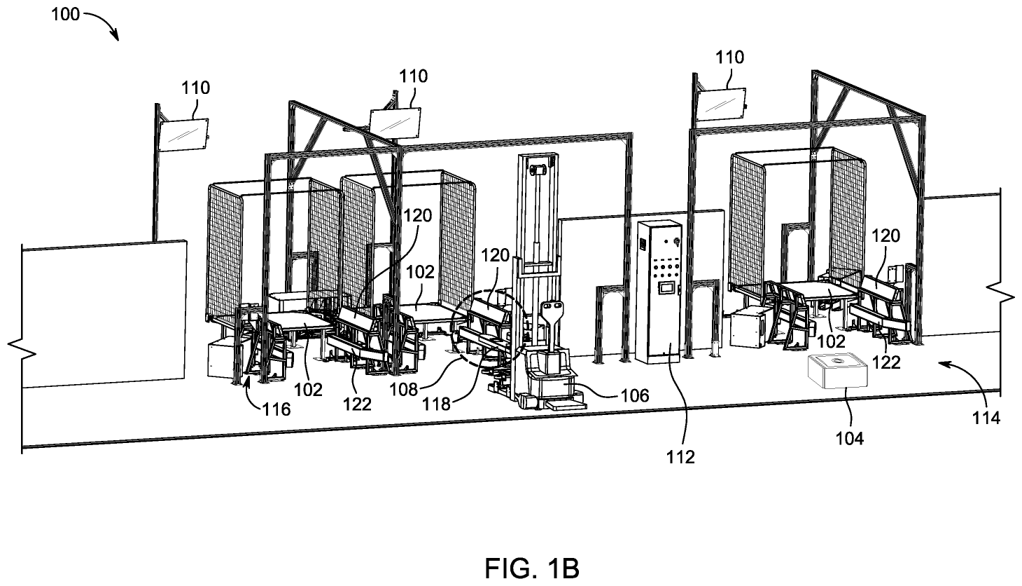

FIG. 1A is an illustration of a transfer of objects from a manually operated environment 10 to a warehouse 20, a management of the objects in the warehouse 20, and, a management of the objects in a Goods-To-Person (GTP) environment 30. In one embodiment, from the fully manual environment 10, objects 40 and 50 may be transferred to the warehouse 20. Two objects 40 and 50 are illustrated for ease of explanation; however, a myriad of objects would be handled in practical situations. The objects 40 and 50 may be stored in the warehouse 20 and may be transferred to the GTP environment 30 upon requirement. The GTP environment 30 may be a completely automated environment, where the objects 40 and 50 may be sorted to reach respective destinations. In one case, as illustrated in FIG. 1A, the GTP environment 30 may include an arrangement of conveyor belts 60, 70, 80, and 90. The objects 40 and 50 placed on the conveyor belt 60 may be guided to any of the conveyor belts 70, 80, and 90 by a robotic arm 100. In one case, the robotic arm 100 may operate based on instructions received from a server. Further, based on the received instructions and identifying a unique code associated with each object, the robotic arm 100 may direct the objects 40 and 50 to suitable directions, in the GTP environment 30.

In one embodiment, the objects may be managed in the warehouse 20 using a pallet pick put system 102. The pallet pick put system 102 may be semi-automatic in nature. Once the objects 40 and 50 are transferred to the warehouse 20, firstly an object 40 may be carried inside the warehouse 20 by a forklift 104. The forklift 104 may place the object 40 on a staging rack 106 in a staging area 108. In one case, if the staging rack 106 is not vacant or the object 40 is found to be damaged, the object 40 may be placed on an exception rack 110. It should be noted that apart from placing the object 40 in the staging area 108 or the exception rack 110, the forklift 104 may be generally moved across a fixed region i.e. a forklift aisle 112. Further, a pallet 114 may be placed beneath the object 40 for carrying the object 40. In one case, the pallet 114 may provide support to the object 40 while being lifted.

The pallet pick put system 102 may further comprise Object Carrying Units (OCUs) 116 for carrying the object 40, wherein the object 40 may rest on the pallet 114 while being placed on an OCU 116. The object 40 supported from beneath by the pallet 114 may be carried by a mechanical equipment 118 using its prongs 120. The pallet pick put system 102 may utilize alignment unit(s) 122 for aligning the mechanical equipment 118 and the pallet 114 carried by the mechanical equipment 118 while the pallet 114 and the object 40 are loaded onto the OCU 116. Further, one or more mirrors 124 may be installed in the pallet pick put system 102 for assisting an operator that operates the mechanical equipment 118. Once the object 40 is placed on the OCU 116 by the mechanical equipment 118, a bot 126 may carry the OCU 116 to a requested location.

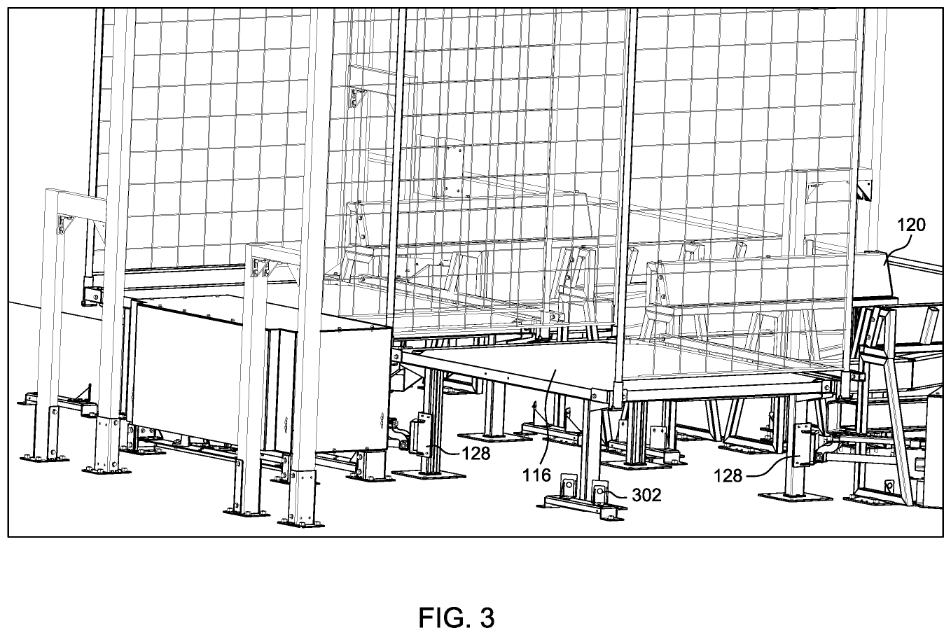

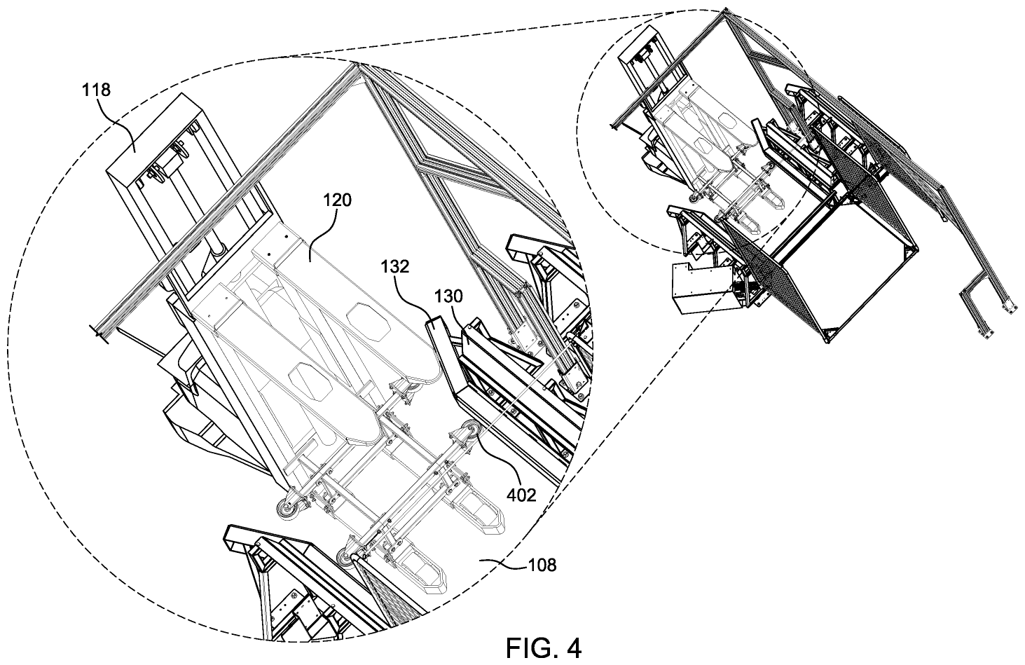

Additional elements/components of the pallet pick put system 102, not illustrated in FIG. 1A, will now be explained with reference to FIG. 1B. In FIG. 1B, there is provided a illustration of a perspective view of the pallet pick put system 102 for transporting the object 40 (henceforth referred generally as object). The pallet pick put system 102 may further utilize a clamping unit 128 for holding the OCUs 116 in their positions. Operational details related to the clamping unit 128 are elaborately described in further sections with reference to FIG. 3. The alignment unit 122 may include a pallet aligner 130 and a mechanical equipment aligner 132. The pallet aligner 130 may be used for correctly aligning the pallet 114 and the mechanical equipment aligner 132 may be used for aligning the mechanical equipment 118. The alignment operation is elaborately described in further sections with reference to FIG. 4. Further, an electrical panel 134 may be present in the pallet pick put system 102 for manually operating or checking operation of different elements, such as the clamping unit 128. Further, station towerlights 136 may be installed at different locations of the pallet pick put system 102 for indicating different operational states of different elements, such as loading of the OCU 116, movement of the OCU 116, and others.

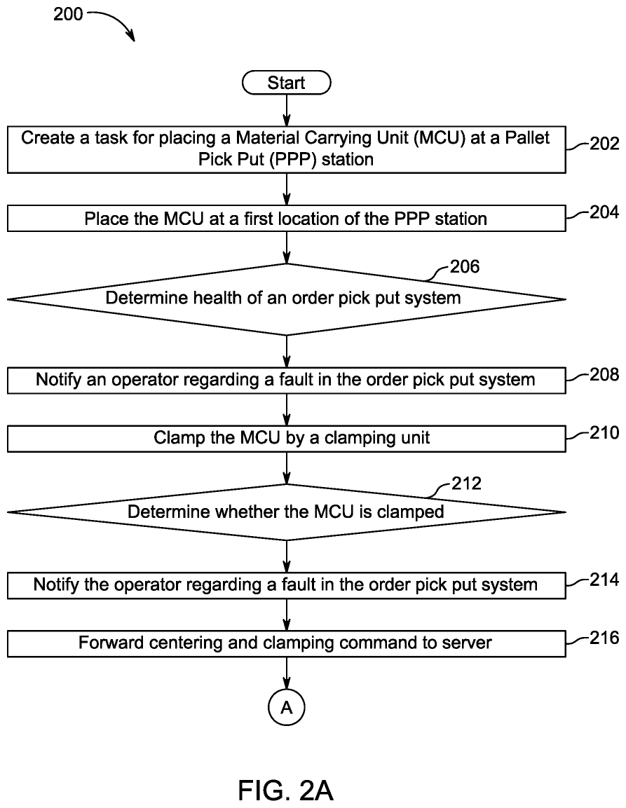

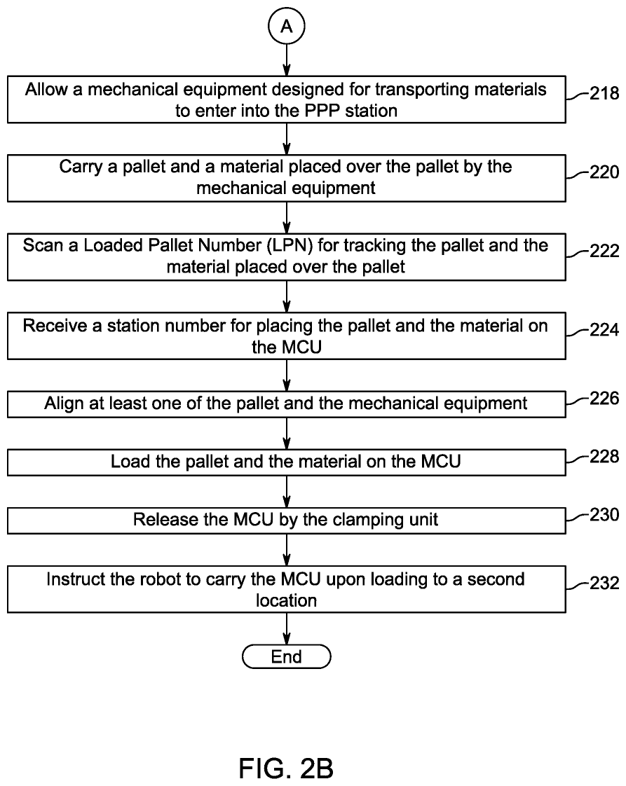

FIGS. 2A and 2B are cumulatively illustrations of a flowchart 200 showing a method for operating a pallet pick put system 102 for transporting objects. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In one embodiment, a task may be created for placing the OCU 116 at a PPP station, at a step 202. The task may require transportation of the object. Successively, a server (not shown) may check readiness of the pallet pick put system 102. Readiness of the pallet pick put system 102 may correspond to determining of several factors, such as determining whether the OCU 116 is vacant, determining if a destination where the OCU 116 needs to be carried is vacant, determining if any obstacle is present in path that is to be followed for carrying the object, determining whether the server is handling any other task, and the like. To determine readiness of the pallet pick put system 102, the server may also receive feedbacks from other units of the pallet pick put system 102, such as stress present on the clamping unit 128.

In one embodiment, readiness of the pallet pick put system 102 may correspond to determining readiness of the clamping unit 128 and a safety module. For the clamping unit 128, a servo mechanism may be responsible for operation of a pair of linear actuators present in the clamping unit 128. The servo mechanism may comprise a servo motor, reed switch, and a servo drive, utilized during clamping and de-clamping operations. Readiness of the clamping unit 128 may be determined based on position of the pair of linear actuators. While both actuators are sensed to be present at a home position, by the reed switch, the clamping unit 128 may be determined to be present in a ready state, else a “System Fault” command may be forwarded to the server. Further, readiness of the safety module may be determined using photoeyes of the safety module. In one case, while presence of an operator or the mechanical equipment 118 is determined in an area of the pallet pick put system 102, using the photoeyes of the safety module, the pallet pick put system 102 may be identified to be present in an unready state. In another case, while presence of the operator or the mechanical equipment 118 is not determined in the area of the pallet pick put system 102, using the photoeyes of the safety module, the pallet pick put system 102 may be identified to be present in a ready state.

Based on readiness of the pallet pick put system 102, the bot 126 may carry the OCU 116 that is empty. The bot 126 may place the OCU 116 at a first location of the PPP station 120, at a step 204. Upon reaching, the OCU 116 may verify the first location using barcodes present on surface of the first location. It should be noted that the bot 126 may receive an address of the first location from the server. Thereafter, the station towerlight 136 may glow red, indicating placement of the OCU 116 at the first location of the PPP station 120.

Successively, health of the pallet pick put system 102 may be determined, at a step 206. Determining the health of the pallet pick put system 102 may include identifying whether the mechanical equipment 118 is present at the PPP station 120 and identifying whether servo motor(s), Programmable Logic Control (PLC), and other hardware devices are healthy.

In one embodiment, determining health of the pallet pick put system 102 may include determining health of the alignment unit 122, the clamping unit 128, and the at least one pair of photoeyes 302. The alignment unit 122 being a mechanical structure, health of the alignment unit 122 is manually inspected by a supervisor, and any identified fault is rectified manually. A health of the clamping unit 128 is determined by servo drives that are responsible for actuator operation. Upon occurrence of errors, such as power failure, disconnection of communication, overload, over-voltage, and encoder issues, the servo drives may forward details pertaining to such errors to a system controller. The system controller may forward such details to the server in form of a “System Fault” command. Health of the at least one pair of photoeyes 302, such as power status, arrangement, and connections, may be monitored using a controller. While any deviations are found in the arrangement or any values, an error signal may be forwarded to the server.

While a fault is identified in the pallet pick put system 102, an operator may be notified about the fault, at a step 208. In one case, the operator may be notified through the station tower light 136. The station towerlight 136 may glow yellow indicating the fault in the pallet pick put system 102. In one case, determining health of the pallet pick put system 102 may refer to determining positioning of the OCU 116.

Positioning of the OCU 116 is explained in reference to FIG. 3; wherein FIG. 3 is an illustration of a perspective view of the pallet pick put system 102. The positioning of the OCU 116 may be determined by at least one pair of photoeyes 302 positioned behind locations for placement of a first diagonal pair of legs of the OCU 116. The pair of photoeyes 302 may be implemented using a suitable photo sensor, such as Light Emitting Diode (LED), Light Amplification by Stimulated Emission of Radiation (LASER), and Infrared (IR) sensor. Further, other sensors such as proximity sensors and ultrasonic sensors could also be used in other embodiments to determine the positioning of the OCU 116. The pair of photoeyes 302 may be arranged such that at least one optical path gets established between the pair of photoeyes 302. While the OCU 116 is misplaced, the optical path is broken down by at least one leg of the OCU 116, resulting into determining mispositioning of the OCU 116. Similarly, multiple optical paths may be established for deriving improved results.

During a verification that the health of the pallet pick put system 102 is determined to be optimal, the OCU 116 may be clamped by a clamping unit 128, at a step 210. In one embodiment, the clamping unit 128 may include the pair of linear actuators, as illustrated in FIG. 3. The pair of linear actuators may be placed behind locations for placement of a second diagonal pair of legs of the OCU 116. The pair of linear actuators may extend in a linear manner and may clamp legs of the OCU 116. In another embodiment, the clamping unit 128 may include a pair of electromagnets placed behind locations for placement of the second diagonal pair of legs of the OCU 116. Using the pair of electromagnets, a clamping strength is beneficially varied to suit different loads. The clamping strength is optionally varied based on electric power provided to the pair of electromagnets. It should be noted that the clamping unit 128 may reduce the OCU 116 placement tolerance. Further, the clamping unit 128 may provide feedback to the server. In one case, the feedback may correspond to any stress sensed by a reed switch attached to the clamping unit 128.

The clamping unit 128 beneficially provides several advantages to operation of the pallet pick put system 102. Primarily, the clamping unit 128 may restrict movement of the OCU 102 while loading an object onto the OCU 116. An operator operating the mechanical equipment 118 without due precision may accidentally hit the OCU 116, by the mechanical equipment 118. In such a case, the clamping unit 128 may restrict movement of the OCU 116 while such accidental impact is made by the mechanical equipment 118. In addition, the clamping unit 128 may also correct mispositioning of the OCU 116 created while being carried by the bot 126, which generally has a tolerance of 10 mm on each side. Thus, the clamping unit 128 may correct all positioning errors related to the OCU 116, occurring during the process. Thus, in above described ways, the clamping unit 128 would enhance operation of the pallet pick put system 102.

In one embodiment, the pallet pick put system 102 may determine whether the OCU 116 is clamped, at a step 212. While the OCU 116 is not clamped, the operator may be notified regarding a fault in the pallet pick put system 102 via the station towerlight 136, at a step 214. The station towerlight 136 (shown in FIG. 1a) may glow yellow indicating the fault in the pallet pick put system 102. In another case, if the clamping of the OCU 116 is complete, a centering and clamping command may be forwarded to the server, at a step 216. Thereafter, the station towerlight 136 may glow green; indicating that the PPP station 120 is ready for the operator to execute further process.

While the OCU 116 is clamped by the clamping unit 128, the mechanical equipment 118 may be allowed to enter into the PPP station 120, at a step 218. The mechanical equipment 118 may be operated by the operator. It should be noted that one or more safety sensors may be used for determining presence of an obstruction in a path of the mechanical equipment 118. The one or more safety sensors may include, but not limited to, LASER infrared based sensor, light curtain sensors, and/or proximity sensors. Movement of the mechanical equipment 118 may be brought to a halt immediately upon detection of an obstruction. The mechanical equipment 118 may be stopped using a mechanical stopper (not shown). Further, the operator may also be notified, about the obstruction, via audio and/or visual indicators. Thus, in above described manner, the one or more safety sensors would enhance operation of the pallet pick put system 102. In one case, the station towerlight 136 may glow red, indicating presence of the obstruction in the path of the mechanical equipment 118.

While the path of the mechanical equipment 118 is clear, a pallet 114 may be lifted by the mechanical equipment 118. Thereafter, the object may be carried over the pallet 114, at a step 220. In one case, the mechanical equipment 118 may comprise of the prongs 120 for carrying the pallet 114 and the object over the pallet 114. In alternate embodiments, carrying means different from the prongs 120, including but not limited to hooks and trays may also be used. Further, the object may be present in or may be packed in containers of any shape, such as cube, cuboid, cylinder, and sphere. The pallet 114 may be designed to comfortably carry the object.

Successively, the operator may scan a Loaded/Licensed Pallet Number (LPN) for tracking the pallet 114 and the object placed over the pallet 114, at a step 222. It should be noted that the LPN may be used for tracking the object within the PPP station 120. In one case, the LPN may be a barcode, a Quick Response (QR) code, a hologram code, a Radio-Frequency Identification (RFID) tag, and the like. In one case, RFID readers may be installed at several locations in the PPP station 120, for determining location of the pallet 114 in the pallet pick put system 102.

Successively, the operator may receive a station number for placing the pallet 114 and the object, on the OCU 116, at a step 224. While the mechanical equipment 118 approaches near the OCU 116, the mechanical equipment 118 may interact with the alignment unit 122 present ahead of the OCU 116. The mechanical equipment 118 may interact with the alignment unit 122 to align at least one of the pallet 114 and the mechanical equipment 118, at a step 226.

The alignment unit 122, its components, and operation are further explained with reference to FIG. 4. The alignment unit 122 may include a pallet aligner 130 and a mechanical equipment aligner 132. The pallet aligner 130 and the mechanical equipment aligner 132 may be present vertically one above other. In one case, the mechanical equipment aligner 132 may be present below the pallet aligner 130 and near to ground.

In one case, the pallet 114 may get misaligned while being wrongly lifted by the operator of the mechanical equipment 118. During such a scenario, the pallet aligner 130 may be used for aligning the pallet 114. In another case, the operator may incorrectly handle the mechanical equipment 118 and may bring the mechanical equipment 118 towards the OCU 116, at an appropriately angle. During such a scenario, the mechanical equipment aligner 132 may be used to align the mechanical equipment 118.

In one embodiment, the mechanical equipment 118 may be aligned using slide guides i.e. guide rails of the mechanical equipment aligner 132. In one case, the guide rails may be a set of 1 to 2 metre (meter) long metal sheets fitted above the ground, at sufficient height to interact with rollers 402 of the mechanical equipment 118. Further, a gap may be present between the guide rails to accommodate the rollers 402 and to provide some clearance. The rollers 402 may be fitted outwards on lower front end of the mechanical equipment 118, and may move over the guide rails in horizontal direction and within the clearance, while the mechanical equipment 118 approaches the OCU 116.

In one embodiment, side guides of the pallet aligner 130 may be used for aligning the pallet 114. The side guides may correspond to a set of sheet metal sections having smooth surfaces. The side guides may be installed onto ground, at a height greater than that of the rollers 402. The sheet metal sections of the side guides may be present at a slanting angle in a range of 18 to 22 degrees from a vertical axis, such that a gap between top edges of the sheet metal sections is greater than a gap between bottom edges of the sheet metal sections. The gap between the top edges of the sheet metal sections may be equal to a size of the pallet 114 added with a major clearance set to include a maximum possible pallet error. The gap between the bottom edges of the sheet metal sections may be equal to a size of the pallet 114 added with a minor clearance set to include a tolerance allowed for pallet placement. After the mechanical equipment 118 is aligned using the guide rails of the mechanical equipment aligner 132, and an operator observes that the pallet 114 is misaligned, the operator may lower down the forks lifting the pallet 114. The pallet 114 may come into contact with the side guides surface, in-between the top edges and the bottom edges, and may get aligned due to weight of the pallet 114 after the pallet 114 reaches the bottom edges of side guides.

Alignment of the pallet 114 and the mechanical equipment 118 by the alignment unit 122 helps in achieving several advantages. Primarily, any damage that could occur by falling of the pallet 114 and the object placed over the pallet 114 is avoided due to their alignment by the alignment unit 122. Further, the mechanical equipment 118 moving even at slightly inaccurate angles, potentially results in falling of the pallet 114 and the object, damage to the mechanical equipment 118, and damage to any element coming into a path of or interacting with the mechanical equipment 118, such as the OCU 116. Such misalignments of the pallet 114 and the mechanical equipment 118 potentially not only increase operational costs, but also demand additional operation time to rectify the damage. Thus, an interaction of the pallet 114 and the mechanical equipment 118 with the alignment unit 122 helps in overcoming such overheads in time and cost.

Upon alignment, the pallet 114 and the object may be unloaded i.e. kept on the OCU 116, at a step 228. Successive to unloading of the pallet 114 and the object on the OCU 116, the clamping unit 128 may release the OCU 116, at a step 230. It should be noted that the station towerlight 136 may glow red immediately after the OCU 116 is released by the clamping unit 128. Thereafter, the bot 126 may be instructed to carry the OCU 116, i.e. loaded OCU to a second location, at a step 232. The bot 126 may be instructed by the server to carry the loaded OCU, thereby transporting the objects.

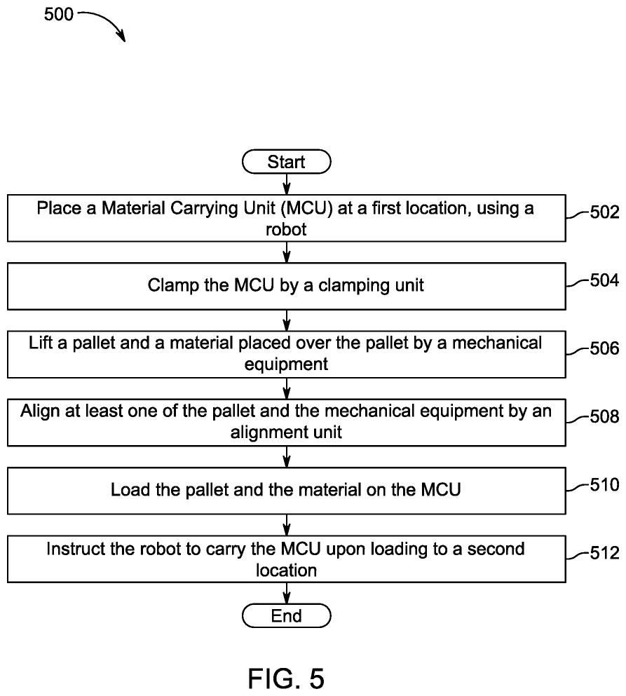

In FIG. 5, here is provided an illustration of a flowchart 500 showing a method for transporting objects using a pallet pick put system 102, according to an embodiment. FIG. 5 comprises a flowchart 500 that is explained in conjunction with the elements disclosed in Figures (FIGs.) explained above.

The flowchart 500 of FIG. 5 shows the architecture, functionality, and operation for operating a pallet pick put system 102 for transporting objects. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 5 may in fact be executed substantially concurrently or the blocks may sometimes be executed in the reverse order, depending upon the functionality involved. Any process descriptions or blocks in flowcharts should be understood as representing modules, or segments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 500 starts at a step 502 and proceeds to a step 512.

At the step 502, an Object Carrying Unit (OCU) 102 may be placed at a first location. The OCU 116 may be placed by a bot 126. The bot 126 may be designed to move the OCU 102 and may receive an address of the first location from a server (not shown), and may place the OCU 116 on the first location.

At a step 504, the OCU 116 may be clamped by a clamping unit 128. The OCU 116 may be clamped to restrict movement of the OCU 116.

At a step 506, a pallet 114 may be lifted for transporting the object. In one case, the object may be placed over the pallet 114.

At a step 508, at least one of the pallet 114 may be aligned using a pallet aligner 130 and the object using the object may be aligned using a mechanical equipment aligner 132.

At a step 510, the pallet 114 and the object 214 placed over the pallet 114 may be transferred on the OCU 116.

At a step 512, the bot 126 may be instructed, by the server, to carry a loaded OCU 116 to a second location. It should be noted that the clamping unit 128 releases the OCU 116 for allowing the bot 126 to carry the loaded OCU 116, thereby transporting the objects.

The invention is not limited to the assignment of functions or operating elements described in the examples to the operating function regions described. The operating function regions may optionally be engaged with other combinations of operating functions and optionally have additional operating functions.

1. A method for operating a pallet pick put system for transporting objects, wherein the method comprises:
placing an Object Carrying Unit (OCU) at a first location, by a bot, wherein the bot is designed to move the Object Carrying Unit (OCU) and receive an address of the first location from a server;
clamping the Object Carrying Unit (OCU) by a clamping unit to restrict movement of the OCU;
lifting a pallet using a mechanical equipment designed for transporting the objects, wherein an object is placed over the pallet;
aligning at least one of the pallet and the mechanical equipment by an alignment unit, wherein the alignment unit comprises a pallet aligner for aligning the pallet and a mechanical equipment aligner for aligning the mechanical equipment;
transferring the pallet on the Object Carrying Unit (OCU), wherein the object is placed over the pallet; and
instructing, by the server, the bot to carry a loaded Object Carrying Unit (OCU) to a second location, wherein the clamping unit releases the OCU for allowing the bot to carry the Object Carrying Unit (OCU) upon loading, thereby transporting the objects.

2. The method recited in claim 1, wherein the Object Carrying Unit (OCU) is clamped to restrict the movement of the Object Carrying Unit (OCU) while loading the object onto the OCU or during an accidental impact made by the mechanical equipment.

3. The method recited in claim 1, wherein the alignment of the Object Carrying Unit (OCU) is determined by at least one pair of photoeyes positioned behind locations for placement of a first diagonal pair of legs of the Object Carrying Unit (OCU).

4. The method recited in claim 1, wherein the clamping unit utilizes a pair of linear actuators positioned behind locations for placement of a second diagonal pair of legs of the Object Carrying Unit (OCU).

5. The method recited in claim 1, wherein the clamping unit utilizes a pair of electromagnets positioned behind locations for placement of a second diagonal pair of legs of the Object Carrying Unit (OCU).

6. The method recited in claim 1, wherein the pallet aligner comprises a first pair of guide rails, and wherein the pallet moves across the first pair of guide rails for alignment of the pallet.

7. The method recited in claim 1, wherein the mechanical equipment aligner comprises a second pair of guide rails, and wherein the mechanical equipment moves across the second pair of guide rails for alignment of the mechanical equipment.

8. The method recited in claim 11, wherein the pallet aligner is present substantially vertical above the mechanical equipment aligner.

9. The method recited in claim 1, further comprising one or more safety sensors for determining presence of an obstruction in a path of the mechanical equipment, and stopping the mechanical equipment while an obstruction is detected.

10. The method recited in claim 9, wherein the one or more safety sensors comprise at least one of a LASER infrared based sensor, a light curtain sensor, and a proximity sensor.

11. The method recited in claim 1, further comprising scanning, by an operator, a Loaded Pallet Number (LPN) for tracking the pallet and the object placed over the pallet.

12. The method recited in claim 1, further comprising indicating different stages in the pallet pick put system using at least one indicator selected from a set of an audio indicator and a visual indicator.

13. A pallet pick put system for transporting objects, wherein the system comprises:
an Object Carrying Unit (OCU) placed at a first location by a bot, wherein the bot is designed to move the Object Carrying Unit (OCU) and receive an address of the first location from a server;
a clamping unit for clamping the Object Carrying Unit (OCU) to restrict movement of the Object Carrying Unit (OCU);
a pallet lifted using a mechanical equipment designed for transporting the objects, wherein an object is placed over the pallet; and
an alignment unit for aligning at least one of the pallet and the mechanical equipment, wherein the alignment unit comprises a pallet aligner for aligning the pallet and a mechanical equipment aligner for aligning the mechanical equipment, wherein the pallet and the object are loaded on the Object Carrying Unit (OCU), wherein the bot is instructed by the server to carry a loaded Object Carrying Unit (OCU) to a second location, and wherein the clamping unit releases the Object Carrying Unit (OCU) for allowing the bot to carry the Object Carrying Unit (OCU) upon loading, thereby transporting the objects.

14. The system recited in claim 13, wherein alignment of the Object Carrying Unit (OCU) is determined by at least one pair of photoeyes positioned behind locations for placement of a first diagonal pair of legs of the Object Carrying Unit (OCU).

15. The system recited in claim 13, wherein the clamping unit utilizes a pair of linear actuators positioned behind locations for placement of a second diagonal pair of legs of the Object Carrying Unit (OCU).

16. The system recited in claim 13, wherein the clamping unit utilizes a pair of electromagnets positioned behind locations for placement of a second diagonal pair of legs of the Object Carrying Unit (OCU).

17. The system recited in claim 13, wherein the pallet aligner comprises a first pair of guide rails, and wherein the pallet moves across the first pair of guide rails for alignment of the pallet.

18. The system recited in claim 13, wherein the mechanical equipment aligner comprises a second pair of guide rails, and wherein mechanical equipment moves across the second pair of guide rails for alignment of the mechanical equipment.

19. The system recited in claim 13, wherein the pallet aligner is present substantially vertical above the mechanical equipment aligner.
